(19) United States
(12) Patent Application Publication
(10) Pub. No.: US 2024/0158022 A1
(43) Pub. Date: May 16, 2024

(54) Methods and Apparatus for Flatbeds

(71) Applicant: Hughes Flatbeds, LLC, Canyon, TX (US)

(72) Inventor: Joe Michael Hughes, Canyon, TX (US)

(73) Assignee: Hughes Flatbeds, LLC, Canyon, TX (US)

(21) Appl. No.: 18/387,944

(22) Filed: Nov. 8, 2023

Related U.S. Application Data
(60) Provisional application No. 63/424,202, filed on Nov. 10, 2022.

(51) Int. Cl. B62D 33/023; B60R 9/02; B60R 9/06

(52) U.S. Cl. CPC B62D 33/023; B60R 9/02; B60R 9/065

(57) ABSTRACT

A flatbed (10) is provided to which left and right-side skirts with wheel wells (14) may be coupled. Sets of skirts are provided with the wheel wells (14) in each set located in a respective predetermined position on the skirts to match a respective truck axle position, the respective predetermined position being different from set to set.

### CROSS-REFERENCE TO RELATED APPLICATION AND PRIORITY INFORMATION

This application claims the benefit of and priority from prior filed U.S. provisional application No. 63/424,202, entitled “Methods and Apparatus for Flatbeds”, filed Nov. 10, 2022, which is incorporated herein by reference in its entirety.

### TECHNICAL FIELD OF THE INVENTION

This invention relates generally to vehicles, and in particular to flatbed trucks.

### BACKGROUND OF THE INVENTION

The bed of a flatbed truck generally has no sides (other than at the front to protect the truck's cab, or to the extent the cab or toolbox, for example, creates a front side). A pickup truck may become a flatbed truck by removing its existing bed and side panels (or ordering the truck without the normal bed and side panels), and then attaching a flatbed to the truck's chassis. On some flatbed trucks, the wheels and truck underside are exposed (un-skirted). In other instances, it is desirable to install a skirt on each side of the flatbed truck, to cover the rear wheels or for aesthetics. Flatbed and skirt assemblies are custom made for the particular model of pickup truck on which they are to be installed.

### SUMMARY OF THE INVENTION

In accordance with the teachings of the present invention, in one embodiment a flatbed assembly is provided, comprising: a flatbed comprising a bed floor, a left side, and a right side, the flatbed further comprising a multiplicity of left-side flatbed fastener holes proximate the left side and a multiplicity of right-side flatbed fastener holes proximate the right side; an engagement assembly comprising a multiplicity of fasteners; and a left-side skirt and a right-side skirt, each skirt comprising a wheel well and a multiplicity of skirt fastener holes, the left-side skirt fastener holes matching the left-side flatbed fastener holes and the right-side skirt fastener holes matching the right-side flatbed fastener holes; wherein the engagement assembly couples the skirts to the flatbed by one each of the fasteners positioned in the respective matching left-side skirt hole and left-side flatbed hole, and one each of the fasteners positioned in the respective matching right-side skirt hole and right-side flatbed hole.

In a particular embodiment, the wheel well of each skirt is located in a wheel-well position, and the fastener holes are located in fastener-hole positions, and the wheel-well position may be selected from a multiplicity of predetermined locations without changing the fastener-hole locations.

In a particular embodiment, the left-side skirt and the right-side skirt form mirror images of one another.

In a particular embodiment, the engagement assembly further comprises at least one left-side wheel well coupler coupled to the left-side wheel well and the flatbed; and at least one right-side wheel well coupler coupled to the right-side wheel well and the flatbed.

In a particular embodiment, each of the skirts comprises a front end, and the engagement assembly further comprises at least one left-side front coupler coupled to the left-side skirt front end and the flatbed; and at least one right-side front coupler coupled to the right-side skirt front end and the flatbed.

In a particular embodiment, at least one of the skirts has a front end, the front end proximate to a cab of a truck on which the flatbed assembly is installed. In another particular embodiment, at least one of the skirts has a front end, and the flatbed assembly further comprises a toolbox coupled to the flatbed so that the toolbox is between the front end of the at least one skirt and a cab of a truck on which the flatbed assembly is installed.

In a particular embodiment, the flatbed further comprises a lower left-side lip and a lower right-side lip, and wherein at least some of the left-side flatbed fastener holes are formed in the lower left-side lip and at least some of the right-side flatbed fastener holes are formed in the lower right-side lip; the left-side skirt further comprises an upper left-side lip and wherein at least some of the left-side skirt fastener holes are formed in the upper left-side lip; and the right-side skirt further comprises an upper right-side lip and wherein at least some of the right-side skirt fastener holes are formed in the upper right-side lip; such that the fasteners positioned in the holes formed in the lips fasten the left-side lower lip to the left-side upper lip and fasten the right-side lower lip to the right-side upper lip.

In a particular embodiment, the fasteners comprise bolts and nuts.

Also provided is a process for assembling a flatbed assembly for a truck having a rear axle defining a left-side wheel location and a right-side wheel location, the process comprising: attaching a flatbed to the truck, the flatbed comprising a bed floor, a left side, and a right side, the flatbed further comprising a multiplicity of left-side flatbed fastener holes proximate the left side and a multiplicity of right-side flatbed fastener holes proximate the right side; providing a multiplicity of skirt sets, each set comprising a respective left-side skirt and a respective right-side skirt each with a wheel well and a multiplicity of skirt fastener holes, the fastener holes of each respective left-side skirt matching the left-side flatbed fastener holes and the fastener holes of each respective right-side skirt matching the right-side flatbed fastener holes, and wherein the left-side wheel well and the right-side wheel well within a respective set have matching positions that correspond to a respective predetermined axle position, the respective predetermined axle position being different from set to set; selecting the skirt set with left-side and right-side wheel well positions that match that of the left-side wheel location and the right-side wheel location of the truck; coupling the skirts of the selected skirt set to the flatbed by positioning fasteners in the respective matching left-side skirt holes and left-side flatbed holes, and by positioning fasteners in the respective matching right-side skirt holes and right-side flatbed holes.

In a particular embodiment, the process also comprises coupling the wheel wells of the selected skirt set to the flatbed.

In a particular embodiment, wherein at least one of the skirts of the selected skirt set has a front end, the process further comprises coupling a toolbox to the flatbed so that the toolbox is between the front end and a cab of the truck on which the flatbed is attached.

Also provided is a flatbed assembly kit, comprising: a flatbed comprising a bed floor, a left side, and a right side, the flatbed further comprising a multiplicity of left-side flatbed fastener holes proximate the left side and a multiplicity of right-side flatbed fastener holes proximate the right side; an engagement assembly comprising a multiplicity of fasteners; and a left-side skirt and a right-side skirt, each skirt comprising a wheel well and a multiplicity of skirt fastener holes, the left-side skirt fastener holes matching the left-side flatbed fastener holes and the right-side skirt fastener holes matching the right-side flatbed fastener holes; wherein the engagement assembly is adapted to couple the skirts to the flatbed when one each of the fasteners is positioned in the respective matching left-side skirt hole and left-side flatbed hole, and one each of the fasteners is positioned in the respective matching right-side skirt hole and right-side flatbed hole.

In a particular embodiment, the wheel well of each skirt is located in a wheel-well position, and the fastener holes are located in fastener-hole positions, and the wheel-well position may be selected from a multiplicity of predetermined locations without changing the fastener-hole locations.

In a particular embodiment, the engagement assembly further comprises: at least one left-side wheel well coupler adapted to couple to the left-side wheel well and the flatbed; and at least one right-side wheel well coupler adapted to couple to the right-side wheel well and the flatbed.

In a particular embodiment, each of the skirts comprises a front end, and the engagement assembly further comprises: at least one left-side front coupler adapted to couple to the left-side skirt front end and the flatbed; and at least one right-side front coupler adapted to couple to the right-side skirt front end and the flatbed.

In a particular embodiment, at least one of the skirts has a front end, the front end spaced apart from the wheel well a predetermined distance so as to be proximate to a cab of a truck on which the flatbed assembly kit is to be installed.

In a particular embodiment, at least one of the skirts has a front end, and the flatbed assembly kit further comprises a toolbox adapted to be coupled to the flatbed so that the toolbox is between the front end of the at least one skirt and a cab of a truck on which the flatbed assembly is to be installed.

In a particular embodiment, the flatbed further comprises a lower left-side lip and a lower right-side lip, and wherein at least some of the left-side flatbed fastener holes are formed in the lower left-side lip and at least some of the right-side flatbed fastener holes are formed in the lower right-side lip; the left-side skirt further comprises an upper left-side lip and wherein at least some of the left-side skirt fastener holes are formed in the upper left-side lip; and the right-side skirt further comprises an upper right-side lip and wherein at least some of the right-side skirt fastener holes are formed in the upper right-side lip; such that when the fasteners are positioned in the holes formed in the lips the left-side lower lip is fastened to the left-side upper lip and the right-side lower lip is fastened to the right-side upper lip.

In a particular embodiment, the fasteners comprise bolts and nuts.

Important technical advantages are provided by the present invention. In particular, and without limitation, by providing different skirts that have wheel wells located to accommodate various rear axle positions, but which have the same fastening locations, a single flatbed model may be used on multiple truck brands, thus reducing the need for custom flatbed assemblies for each truck brand.

Another important technical advantage of the present invention is that it allows skirts to be coupled to flatbeds with nuts and bolts, thus allowing for easy installation, removal, and re-use of the flatbeds and the skirts, without the need for welding for attachment and without the need for weld grinding for removal.

### BRIEF DESCRIPTION OF THE DRAWINGS

Reference is made in the description to the following briefly described drawings, which are not drawn to scale, and in which like reference numerals indicate like features:

FIG. 1 is a perspective view of one embodiment of a flatbed and skirt according to the teachings of the present invention;

FIG. 2 is a slightly perspective side view of the embodiment of FIG. 1;

FIG. 3 is a perspective top view of one embodiment of an unattached skirt and toolbox according to the teachings of the present invention;

FIG. 4 is a perspective view of one embodiment of features for coupling a skirt to a flatbed according to the teachings of the present invention;

FIGS. 5A and 5B are sectional views of the embodiment of FIG. 4;

FIG. 6 is a perspective top view of one embodiment for coupling skirts to the rear of a flatbed according to the teachings of the present invention;

FIG. 7 is a perspective bottom view of one embodiment of wheel well couplers according to the teachings of the present invention;

FIG. 8 is a perspective view of one embodiment of front couplers according to the teachings of the present invention;

FIG. 9 is a sectional view taken along the line shown in FIG. 8; and

FIG. 10 is a top perspective view of one embodiment of un-assembled engagement members for coupling one skirt to a flatbed according to the teachings of the present invention.

### DETAILED DESCRIPTION OF THE INVENTION

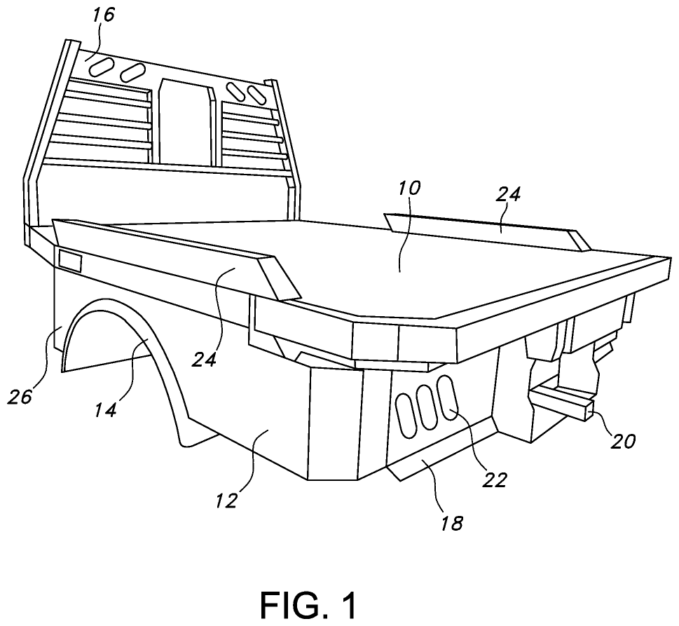

FIG. 1 is a perspective view of one embodiment of a flatbed 10, showing a view from the rear left side toward the front. Orientations in this description relate to common United States truck references, with the truck cab being toward the front, the driver side being the left side, and the passenger side being the right side. Also, as used herein, longitudinal refers to front-to-back and vice versa, and transverse refers to left-to-right and vice versa.

Also shown in FIG. 1 is left-side skirt 12 having wheel well (also sometimes referred to as a fender) 14, the skirt 12 being coupled to the left side of flatbed 10. A right-side skirt (not shown) and its wheel well, which is a mirror image of left-side skirt 12, is coupled to the right side of flatbed 10. The longitudinal location of the wheel wells of the left and right-side skirts are determined by the location of the rear axle of the truck on which the flatbed and skirts are to be installed.

FIG. 1 also shows various optional features, such as a cab protector (also known as a headache rack) 16, a rear skirt 18, a trailer hitch 20, and one or more light holes 22 (for rear vehicle lights), and articulating arms 24 (which may be hydraulically operated and hingedly coupled to the flatbed 10, and operable to articulate with respect to the flatbed 10 to engage and load (or rollout) round haybales). As a particular example, flatbed 10 may be dimensioned to accommodate two large round haybales.

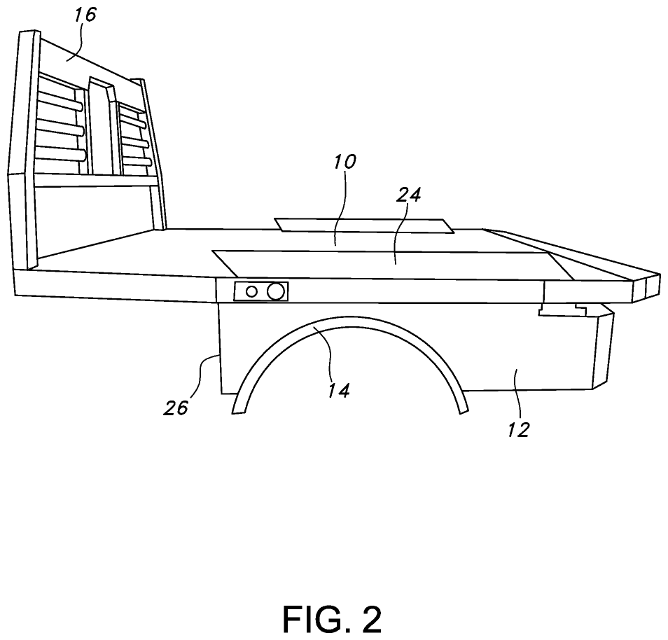

FIG. 2 is a slightly perspective side view of flatbed 10 and skirt 12 of FIG. 1.

The left and right-side skirts may extend longitudinally from their respective wheel wells all the way toward the front of the flatbed 10 (for example proximate the truck cab or cab protector 16) or only some of the way. In particular, the skirts have a front edge 26 in front of the wheel well 14. The front edge 26 may be spaced apart from wheel well 14 as desired. In the embodiment shown in FIGS. 1-3, front edge 26 is located relatively close to wheel well 14 to allow room for a toolbox 28 to be coupled to the flatbed 10 so that the toolbox 28 is between the wheel well 14 and the cab of the truck on which the flatbed assembly is to be installed. A toolbox 28 may be coupled to one or both of the left and right sides of flatbed 10.

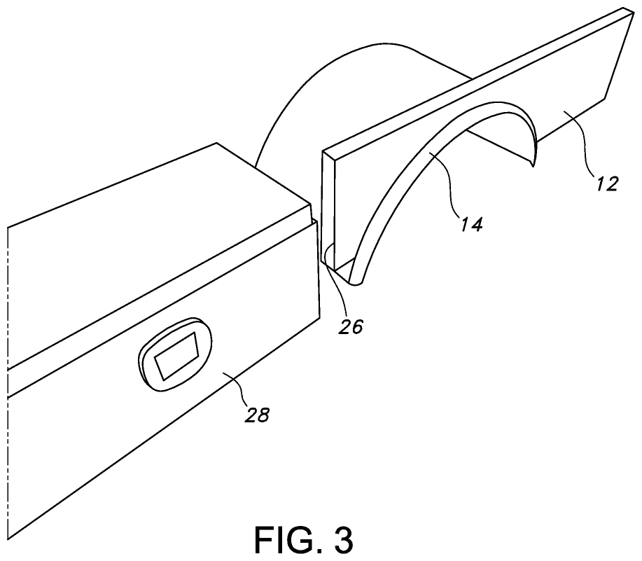

FIG. 3 shows skirt 12 and toolbox 28 before they are coupled to flatbed 10.

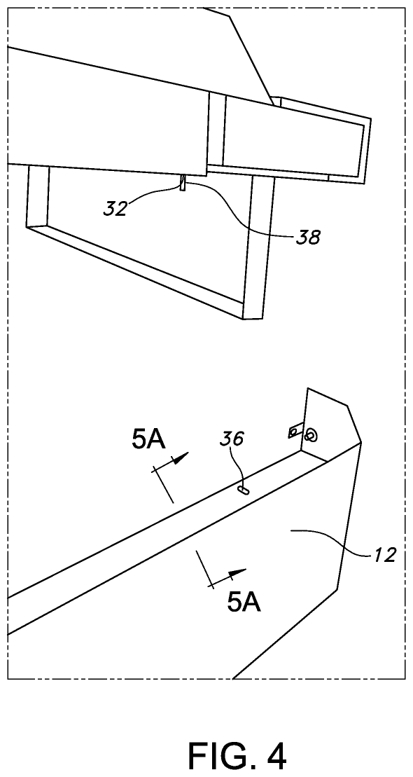

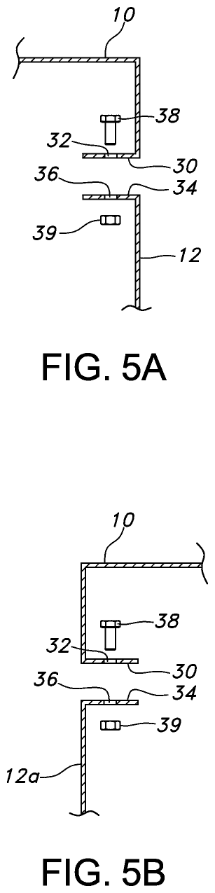

FIGS. 4 and 5A-B show one embodiment of features for coupling left-side skirt 12 (FIG. 5A) and right-side skirt 12a (FIG. 5B) to the flatbed 10. In this embodiment, flatbed 10 includes, at its left and right sides, a lower horizontal lip 30 running along at least a portion of the bottom of each side, with a multiplicity of flatbed fastener holes 32 therein (one being shown). The left and right-side skirts each include an upper horizontal lip 34 running along at least a portion of the top of each skirt and having a multiplicity of skirt fastener holes 36 therein (one being shown). The flatbed fastener holes 32 match the position of the skirt fastener holes 36. As best shown by the sectional exploded views of FIGS. 5A (left side) and 5B (right side) (both looking toward the back), fasteners 38 are positioned through the holes 32 and 36 to couple the skirts to the flatbed 10. Fasteners 38 may be any suitable fastener, but preferably bolts with securing nuts 39.

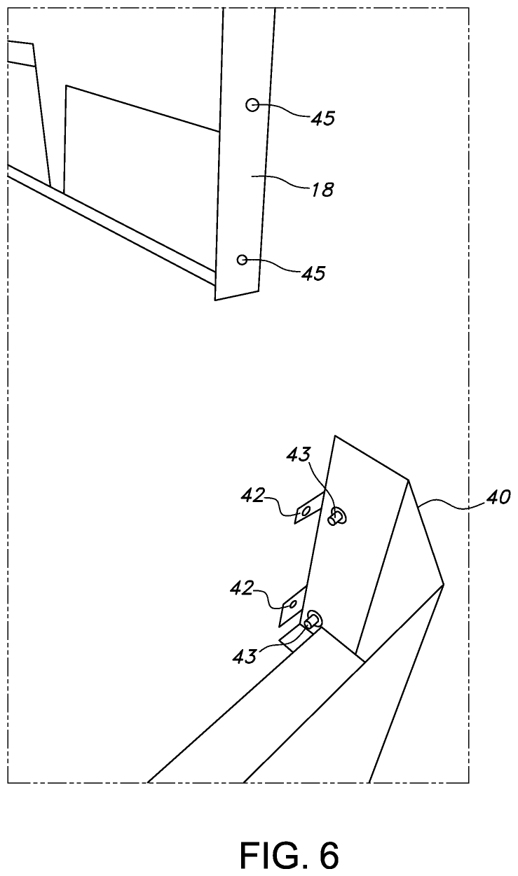

FIG. 6 shows one embodiment for coupling the left and right-side skirts to the rear of the flatbed 10. The left-side and right-side coupling are mirror images. In this embodiment, each of the left and right-side skirts includes a rear transverse member 40 to which one or more L-brackets 42 are attached as shown. One end of each of the L-brackets 42 couples to the respective rear member 40, and the other couples to the flatbed 10, for example by coupling to a respective side of rear skirt 18. The L-brackets 42 have fastener holes that align with matching fastener holes in the rear members 40 and the rear skirt 18 (those in the rear skirt 18 are shown as holes 45). Fasteners 43 (two of which are shown) are positioned through the fastener holes in the L-brackets 42 and those in the rear members 40 and the holes 45 of rear skirt 18 to couple the skirts to the flatbed 10. Fasteners 43 may be any suitable fastener, but preferably bolts with securing nuts.

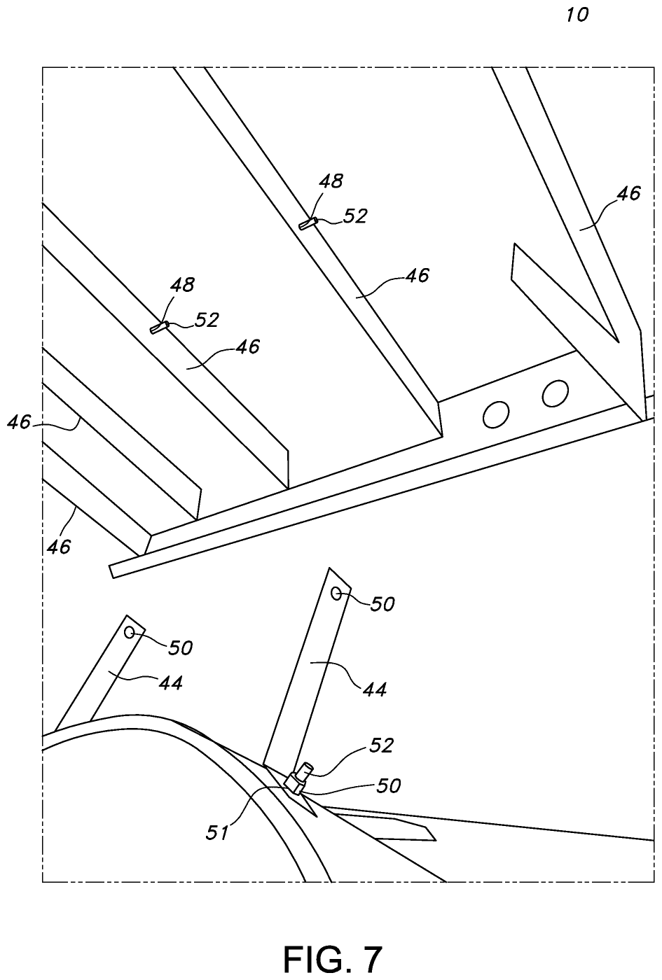

FIG. 7 illustrates one embodiment of additional coupling members 44 (one embodiment of wheel well couplers) for further coupling of the left and right-side skirts to flatbed 10. The left-side will be illustrated, with the right-side being a mirror image. As shown in FIG. 7, the underside of flatbed 10 includes transverse support members 46, having one or more fastener holes 48. Wheel well couplers 44 may be elongated brackets with one or more fastener holes 50 near each end. One or more of the couplers are coupled to the wheel well 14 and to the flatbed 10. In particular, this coupling occurs with fasteners 52 positioned through the fastener holes 50 and fastener holes 51 in the wheel wells and fastener holes 48 in the transverse support members 46. Fasteners 52 may be any suitable fastener, but preferably bolts with securing nuts. Preferably two coupling members 44 are used on each wheel well, each spaced apart from the top of the respective wheel well by about 60 degrees.

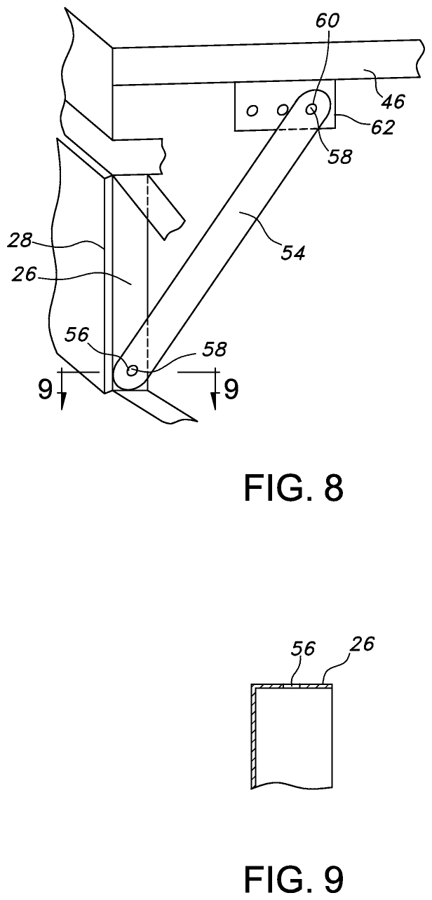

FIGS. 8 and 9 illustrate an embodiment of securing straps 54 (one embodiment of front couplers) used to secure the front of the left and right-side skirts to the flatbed 10. The left-side will be illustrated, with the right-side being a mirror image. As shown, front edge 26 is a vertical lip, through which a fastener hole 56 is provided. Front coupler 54 has fastener holes 58 near each end, one of which matches with fastener hole 56, and the other with a fastener hole 60 of flatbed 10. Hole 60 may be in a transverse support member 46, or on a plate 62 coupled to and descending from flatbed 10. Plate 10 may include other fastener holes for coupling of toolboxes 28 or other accessories. Fasteners 64 are passed through the fastener holes 58 and the matching holes 56 and 60 to couple the front of the skirt to the flatbed 10. The fasteners 64 may be any suitable fastener, but preferably bolts with securing nuts.

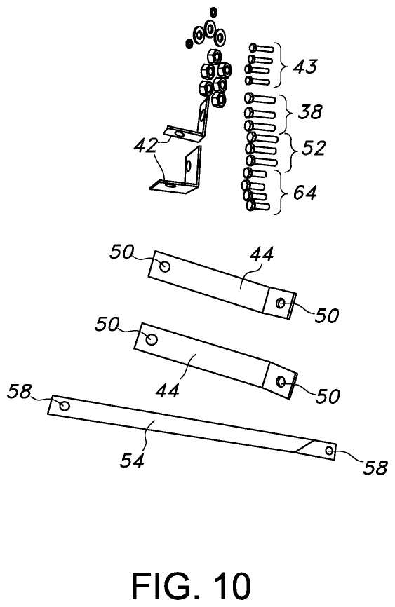

FIG. 10 shows one example of un-assembled engagement members discussed above, used to couple one skirt to the flatbed 10.

With the present invention, different sets of left-side and right-side skirts (the skirts discussed above) are provided for different model trucks (for example, Ford, GM, and Dodge trucks (Ford, GM, and Dodge are registered trademarks of their respective owners)), with the difference in the sets being related to the wheel wells. In particular, different model trucks have different rear axle positions, and the wheel wells in each respective set are positioned on the left-side and right-side skirts to be substantially longitudinally centered on the axle and to accommodate the wheels for the particular truck model on which they are to be installed. However, other than the wheel well position (and possibly the position or shape of the wheel well couplers), the skirts from the different sets are otherwise substantially the same, and couple to the flatbed in the same manner. Therefore, one flatbed model may be used with the skirts for multiple truck models, as the skirts of each different set attach to the flatbed in the same way and in the same locations. In some embodiments, it may be appropriate to change the location of wheel well fastener holes 51, or the length or angle of wheel well couplers 44, from skirt-set to skirt-set, to accommodate the different wheel well locations and coupling of the wheel well couplers 44 to the flatbed 10 (with fasteners in fastener holes 48). However, in other embodiments, the locations of holes 51 with respect to the wheel well center and the length and angle of wheel well couplers 44 are substantially the same from set to set. Furthermore, additional holes 48 may be made in the flatbed 10 to accommodate the coupling of wheel well couplers 44 in different positions on flatbed 10, to accommodate differences brought about by the different wheel well (and holes 51) positions. Also, more than one hole 50 may be made at one or both ends of wheel well couplers 44 to accommodate for differences brought about by the different wheel well (and holes 51) positions. With these accommodations, the same wheel well couplers 44 may be used from set to set.

The ability to use a single flatbed model with multiple different skirt sets is an important advantage of the present invention because, among other things, it reduces inventory and manufacturing costs. Similarly, the ability to use the same coupling members from set to set is an important advantage of the present invention.

Also provided is a process for assembling a flatbed assembly for a truck having a particular rear axle location (the axle location defines a left-side wheel location and a right-side wheel location). In this process, a flatbed 10 according to the teachings herein is attached to the truck. Also, the multiple skirt sets discussed above are provided, and a skirt set is selected that has left-side and right-side wheel well positions that match that of the left-side wheel location and the right-side wheel location of the particular truck model. Then, the skirts are coupled to the flatbed by positioning fasteners in the respective matching left-side skirt holes and left-side flatbed holes, and by positioning fasteners in the respective matching right-side skirt holes and right-side flatbed holes. The process may further include coupling the wheel wells of the selected skirt set to the flatbed. Also, the process may include coupling a toolbox to the flatbed so that the toolbox is between one of the skirts and a cab of the truck on which the flatbed is attached. A toolbox may be coupled on one or both sides of the truck.

In particular embodiments, the flatbed and skirts may me formed from or covered with diamond plate sheet steel. Single or multiple sheets may be used, with the multiple sheets suitably joined, for example by welding. The sheet(s) may be bent to form sides and lips, or separate sheet pieces may be suitably joined to form the sides and lips.

In some embodiments, one or more of the fasteners and fastener holes may be located so they are “hidden” from view (except by looking underneath).

In some embodiments, one end of L-brackets 42, or one end of the wheel well couplers 44, or one end of the front couplers 54 is welded to the flatbed 10 or to the skirt, while fastening the other end with fasteners. This option may speed up installation and removal of the skirts. Also, in some embodiments the fastener nuts may be formed or suitably fixed in place (for example by welding our glue), to allow easy installation of the fasteners through the respective holes and in threaded engagement with the in-place nuts. Furthermore, the nuts (whether separate or fixed in place) may be made of any suitable material, including metal or nylock, and rubber washers may be used to reduce rattle.

As used herein, coupled and couples include direct connection or indirect connection through one or more intermediate members.

Particular features of the example embodiments may be used with, added to, or substituted in the other example embodiments.

Although the present invention has been described in detail, it should be understood that various changes, alterations, substitutions, additions, and modifications could be made without departing from the intended scope of the invention, as defined in the following claims.

What is claimed is:

1. A flatbed assembly, comprising:
a flatbed comprising a bed floor, a left side, and a right side, the flatbed further comprising a multiplicity of left-side flatbed fastener holes proximate the left side and a multiplicity of right-side flatbed fastener holes proximate the right side;
an engagement assembly comprising a multiplicity of fasteners; and
a left-side skirt and a right-side skirt, each skirt comprising a wheel well and a multiplicity of skirt fastener holes, the left-side skirt fastener holes matching the left-side flatbed fastener holes and the right-side skirt fastener holes matching the right-side flatbed fastener holes;
wherein the engagement assembly couples the skirts to the flatbed by one each of the fasteners positioned in the respective matching left-side skirt hole and left-side flatbed hole, and one each of the fasteners positioned in the respective matching right-side skirt hole and right-side flatbed hole.

2. The flatbed assembly of claim 1, wherein the wheel well of each skirt is located in a wheel-well position, and the fastener holes are located in fastener-hole positions, and the wheel-well position may be selected from a multiplicity of predetermined locations without changing the fastener-hole locations.

3. The flatbed assembly of claim 1, wherein the left-side skirt and the right-side skirt form mirror images of one another.

4. The flatbed assembly of claim 1, wherein the engagement assembly further comprises:
at least one left-side wheel well coupler coupled to the left-side wheel well and the flatbed; and
at least one right-side wheel well coupler coupled to the right-side wheel well and the flatbed.

5. The flatbed assembly of claim 1, wherein each of the skirts comprises a front end, and wherein the engagement assembly further comprises:
at least one left-side front coupler coupled to the left-side skirt front end and the flatbed; and
at least one right-side front coupler coupled to the right-side skirt front end and the flatbed.

6. The flatbed assembly of claim 1, wherein at least one of the skirts has a front end, the front end proximate to a cab of a truck on which the flatbed assembly is installed.

7. The flatbed assembly of claim 1, wherein at least one of the skirts has a front end, and further comprising a toolbox coupled to the flatbed so that the toolbox is between the front end of the at least one skirt and a cab of a truck on which the flatbed assembly is installed.

8. The flatbed assembly of claim 1, wherein:
the flatbed further comprises a lower left-side lip and a lower right-side lip, and wherein at least some of the left-side flatbed fastener holes are formed in the lower left-side lip and at least some of the right-side flatbed fastener holes are formed in the lower right-side lip;
the left-side skirt further comprises an upper left-side lip and wherein at least some of the left-side skirt fastener holes are formed in the upper left-side lip; and
the right-side skirt further comprises an upper right-side lip and wherein at least some of the right-side skirt fastener holes are formed in the upper right-side lip;
such that the fasteners positioned in the holes formed in the lips fasten the left-side lower lip to the left-side upper lip and fasten the right-side lower lip to the right-side upper lip.

9. The flatbed assembly of claim 1, wherein the fasteners comprise bolts and nuts.

10. A process for assembling a flatbed assembly for a truck having a rear axle defining a left-side wheel location and a right-side wheel location, the process comprising:
attaching a flatbed to the truck, the flatbed comprising a bed floor, a left side, and a right side, the flatbed further comprising a multiplicity of left-side flatbed fastener holes proximate the left side and a multiplicity of right-side flatbed fastener holes proximate the right side;
providing a multiplicity of skirt sets, each set comprising a respective left-side skirt and a respective right-side skirt each with a wheel well and a multiplicity of skirt fastener holes, the fastener holes of each respective left-side skirt matching the left-side flatbed fastener holes and the fastener holes of each respective right-side skirt matching the right-side flatbed fastener holes, and wherein the left-side wheel well and the right-side wheel well within a respective set have matching positions that correspond to a respective predetermined axle position, the respective predetermined axle position being different from set to set;
selecting the skirt set with left-side and right-side wheel well positions that match that of the left-side wheel location and the right-side wheel location of the truck;
coupling the skirts of the selected skirt set to the flatbed by positioning fasteners in the respective matching left-side skirt holes and left-side flatbed holes, and by positioning fasteners in the respective matching right-side skirt holes and right-side flatbed holes.

11. The process of claim 10, and further comprising coupling the wheel wells of the selected skirt set to the flatbed.

12. The process of claim 10, wherein at least one of the skirts of the selected skirt set has a front end, and further comprising coupling a toolbox to the flatbed so that the toolbox is between the front end and a cab of the truck on which the flatbed is attached.

13. A flatbed assembly kit, comprising:
a flatbed comprising a bed floor, a left side, and a right side, the flatbed further comprising a multiplicity of left-side flatbed fastener holes proximate the left side and a multiplicity of right-side flatbed fastener holes proximate the right side;
an engagement assembly comprising a multiplicity of fasteners; and
a left-side skirt and a right-side skirt, each skirt comprising a wheel well and a multiplicity of skirt fastener holes, the left-side skirt fastener holes matching the left-side flatbed fastener holes and the right-side skirt fastener holes matching the right-side flatbed fastener holes;
wherein the engagement assembly is adapted to couple the skirts to the flatbed when one each of the fasteners is positioned in the respective matching left-side skirt hole and left-side flatbed hole, and one each of the fasteners is positioned in the respective matching right-side skirt hole and right-side flatbed hole.

14. The flatbed assembly kit of claim 13, wherein the wheel well of each skirt is located in a wheel-well position, and the fastener holes are located in fastener-hole positions, and the wheel-well position may be selected from a multiplicity of predetermined locations without changing the fastener-hole locations.

15. The flatbed assembly kit of claim 13, wherein the engagement assembly further comprises:
at least one left-side wheel well coupler adapted to couple to the left-side wheel well and the flatbed; and
at least one right-side wheel well coupler adapted to couple to the right-side wheel well and the flatbed.

16. The flatbed assembly kit of claim 13, wherein each of the skirts comprises a front end, and wherein the engagement assembly further comprises:
at least one left-side front coupler adapted to couple to the left-side skirt front end and the flatbed; and
at least one right-side front coupler adapted to couple to the right-side skirt front end and the flatbed.

17. The flatbed assembly kit of claim 13, wherein at least one of the skirts has a front end, the front end spaced apart from the wheel well a predetermined distance so as to be proximate to a cab of a truck on which the flatbed assembly kit is to be installed.

18. The flatbed assembly kit of claim 13, wherein at least one of the skirts has a front end, and further comprising a toolbox adapted to be coupled to the flatbed so that the toolbox is between the front end of the at least one skirt and a cab of a truck on which the flatbed assembly is to be installed.

19. The flatbed assembly kit of claim 13, wherein:
the flatbed further comprises a lower left-side lip and a lower right-side lip, and wherein at least some of the left-side flatbed fastener holes are formed in the lower left-side lip and at least some of the right-side flatbed fastener holes are formed in the lower right-side lip;
the left-side skirt further comprises an upper left-side lip and wherein at least some of the left-side skirt fastener holes are formed in the upper left-side lip; and
the right-side skirt further comprises an upper right-side lip and wherein at least some of the right-side skirt fastener holes are formed in the upper right-side lip;
such that when the fasteners are positioned in the holes formed in the lips the left-side lower lip is fastened to the left-side upper lip and the right-side lower lip is fastened to the right-side upper lip.

20. The flatbed assembly kit of claim 13, wherein the fasteners comprise bolts and nuts.
